(19) United States
(12) Patent Application Publication
(10) Pub. No.: US 2016/0097906 A1
(43) Pub. Date: Apr. 7, 2016

(54) APPARATUS WITH SUBSTANTIALLY RIGID SUPPORT

(71) Applicant: AKER SUBSEA LIMITED, Maidenhead (GB)

(72) Inventors: Stuart REID, Maidenhead (GB); Daniel AHRENS, Maidenhead (GB); Kenneth HOOD, Maidenhead (GB)

(21) Appl. No.: 14/875,991

(22) Filed: Oct. 6, 2015

(30) Foreign Application Priority Data
Oct. 7, 2014 (GB) 1417751.3

(51) Int. Cl. G02B 6/42; H01B 9/00; G02B 6/44

(52) U.S. Cl. CPC G02B 6/428; G02B 6/4434; G02B 6/4427; G02B 6/4478; G02B 6/4416; G02B 6/4254; G02B 6/4284; H01B 9/005

(57) ABSTRACT

An apparatus (10) for use subsea including a container having an aperture, a lid (12) securable to the container to cover the aperture, a printed circuit board, at least one fibre-optic (18) connecting the printed circuit board to the lid (12) and a substantially rigid support (14) locatable in the container. The lid (12) is suitable to isolate the inside of the container from the outside of the container when fluid pressure outside the container is at least 1000 kPa. The support (14) has at least one upstanding member around which one or more fibre-optics (18) are locatable such that the smallest radius of a bend in the fibre-optic(s) (18) is greater than the minimum bend radius thereof.

The present invention relates to an apparatus for use subsea, especially a Subsea Electronic Module comprising printed circuit boards.

Subsea Control Modules (SCMs) are commonly used in the oil and gas industry. Most SCMs have a plate for attaching the SCM to a subsea tree, a sealed electronics chamber and a series of valves that can be used to control fluid and electrical lines that pass through the tree and into a well. The sealed electronics chamber is often referred to as a Subsea Electronics Module (SEM).

There are many different designs of SEMs but most comprise an open ended canister and a cap that fits onto and closes the canister. The cap has an electrical connector with electrical connections that provide electrical communication between electrical components, such as printed circuit boards, inside the canister and the outside.

Improving the electrical communication between the electrical components inside the canister and the electrical connector in the cap would be advantageous. The inventors of the present invention are however aware of the numerous drawbacks of using anything other than conventional wires to provide this electrical communication and of the physical conditions the means of electrical communication must withstand, including vibration and shock testing of the apparatus.

In accordance with a first aspect of the present invention there is provided an apparatus for use subsea, the apparatus comprising:
a container having at least one aperture;
a lid securable to the container to cover the at least one aperture, suitable to isolate the inside of the container from the outside of the container when fluid pressure outside the container is at least 1000 kPa, optionally 5000 kPa;
at least one printed circuit board;
at least one fibre-optic connecting the printed circuit board to the lid; and
a substantially rigid support locatable in the container, the substantially rigid support having at least one upstanding member around which one or more fibre-optics are locatable such that the smallest radius of a bend in the one or more fibre-optics, or a radius of curvature of the at least one upstanding member, is greater than the minimum bend radius of the one or more fibre-optics.

The Minimum Bend Radius (MBR) may also be referred to as the bend radius. The minimum bend radius is the minimum radius that the one or more fibre-optics can be bent around without damaging and/or kinking the one or more fibre-optics and for attenuation reasons. Damaging the one or more fibre-optics can cause loss of communication in entirety or may shorten their working life. The minimum bend radius of the one or more fibre-optics is typically from 10 to 200 mm, normally from 10 to 100 mm and optionally from 10 to 30 mm.

The minimum bend radius is particularly important when handling fibre-optics. A fibre-optic cable that has been bent beyond its minimum bend radius and/or has been bent excessively can suffer from micro-bending and/or macro-bending losses. It may be an advantage of the present invention that the one or more fibre-optics are not bent beyond their minimum bend radius during installation or vibration and/or shock testing of the apparatus.

The at least one upstanding member may be one of a plurality of upstanding members, such as at least three or at least five. The plurality (or array) of upstanding members typically define one or more pathways for the one or more fibre-optics. The one or more fibre-optics may be windable around the at least one upstanding member and/or the plurality of upstanding members and/or the one or more pathways. The at least one or each upstanding member extends from the main plane of the substantially rigid support and terminates at a top side. The outer surface of the/each upstanding member between the substantially rigid support and the top side, is typically curved in the direction generally parallel to the main plane of the substantially rigid support. Thus it has an outer curved surface with said radius of curvature.

In use the one or more fibre-optics are, at least in part, in contact with the outer curved surface. In use the one or more fibre-optics may be wound around the outer curved surface. The outer curved surface of the at least one upstanding member may be referred to as arcuate.

The radius of curvature of the curved surface is preferably greater than the minimum bend radius of the one or more fibre-optics.

The curved outer surface may be separated into more than one curved portion, such as three or four portions; each portion with a different radius of curvature.

An upstanding member may be wing-shaped (including three portions of different radius of curvature). Or it may be shield-shaped (including four portions of different radius of curvature). A mixture of wing-shaped and shield-shaped upstanding members is preferred. The array may include wing-shaped upstanding members on an outer edge of the array.

As an alternative, the upstanding members may be lens shaped or concave shape with two portions of curvature on opposite sides of the upstanding member. This is a preferred arrangement for a second, upper substantially rigid support.

The array of upstanding members may include three or more spaced apart around the substantially rigid support. A portion of their respective outer curved surfaces, especially on a relatively outer side of the array, may define a substantially oval pattern. The oval pattern does not need to be an exact geometric oval.

Relative to a centre point between two or more upstanding members, the curved outer surface of at least a portion of the curved outer surface, may be concave in shape.

The substantially rigid support may be referred to as a fibre-optic management system. The substantially rigid support may be referred to as a ramp. The substantially rigid support may be referred to as a management tray. The one or more fibre-optics are typically held in place on the substantially rigid support by a cord or tape. The cord or tape may be referred to as cable lacing.

It is typically necessary to store a length of each of the one or more fibre-optic cables in the container because there is a minimum length of fibre-optic cable recommended to allow for re-termination in the event of damage or failed terminations. It may be an advantage of the present invention that the substantially rigid support is able to provide support and/or store the required length of cable such that the smallest radius of a bend in each cable is greater than the minimum bend radius of the cable.

The lid of the apparatus typically further comprises one or more electrical connections providing electrical communication from a first side of the lid to a second side of the lid. The lid may have one or more optical connector for connection to the fibre optics. The one or more optical connections may be one or more optical penetrators.

It may be an advantage of the present invention that the substantially rigid support provides support for the one or more fibre-optics between the lid and the at least one printed circuit board in the container.

The substantially rigid support is typically securable to the lid. The substantially rigid support may be securable to the lid in proximity to the one or more optical connections providing optical communication from the first side of the lid to the second side of the lid.

The substantially rigid support normally has an at least substantially planar face. The at least one upstanding member is typically on the at least substantially planar face. The at least substantially planar face of the substantially rigid support is normally inclined to the first side of the lid. The angle of inclination may be 20-80 degrees, or 40-60 degrees. The at least substantially planar face of the substantially rigid support may be perpendicular and/or parallel to the first side of the lid.

The substantially planar face of the substantially rigid support may have a curved surface adjacent the lid. In use the one or more fibre-optics may rest on the curved surface. The curved surface may have a radius of curvature greater than the minimum bend radius of the one or more fibre-optics.

Each of the further substantially rigid supports may have a combination of features described for the first substantially rigid support and certain embodiments have two or more substantially rigid supports with different features (for example, a different number of upstanding members.) A second substantially rigid support may be securable to a first substantially rigid support. The first substantially rigid support may have one or more posts that are useable to support the second substantially rigid support. The one or more posts may be referred to as one or more pillars. The one or more posts are typically used to space the second substantially rigid support from the first substantially rigid support.

The apparatus is typically ISO 13628-6:2006 compliant.

The apparatus may be a Subsea Electronic Module (SEM). Typically this can be used to control fluid, electrical lines and or other lines that pass through the tree and into a well.

The pressure inside the container may be from 100 to 200 kPa. The lid may have one or more ports so that the atmosphere inside the container can be controlled from outside the container.

The apparatus is suitable for use subsea, that is, its inside can be isolated from its outside when the outside pressure is at least 1000 kPa, or 5000 kPa that is in a depth of around 500 m.sw (meters of sea water). This is a significant force (10 or 50 times atmospheric pressure) and so clearly distinguished from surface equipment. Indeed, normally it is rated to be used at greater depths, and pressures. For example, rated to a pressure more than 10,000 kPa, or more than 20,000 kPa, and up to a pressure outside the container of 30,000 kPa (or 40,000 kPa) typically equal to a pressure at a depth of 3,000 (or 4,000 respectively) m.sw (meters of sea water). The lid may be securable to the container to cover the at least one aperture thereby isolating inside from outside the container when fluid pressure outside the container is up to 45,000 kPa. The pressure outside the container of 45,000 kPa is typically equal to a pressure at a depth of 4,500 m.sw (meters of sea water).

The apparatus may be operable at temperatures of from −40° C. to +150° C.

The container may be cylindrical. When the apparatus is assembled the first side of the lid is normally innermost and/or inside the container and the second side of the lid is normally outermost and/or forms part of an outer surface of the apparatus. When the lid is secured to the container the container may be referred to as being sealed and/or air-tight. Normally the apparatus is gas filled, for example with dry nitrogen.

The container may have a first and a second aperture. The first and second apertures may be at opposing ends of the container. When the container is cylindrical the container may be a hollow tube. The container may be referred to as a canister.

When the container has a first and a second aperture, the apparatus typically comprises a second lid. The lid of the apparatus according to the first aspect of the present invention may be referred to as a first lid. The first and second lids may be the same or may be different. The second lid is typically securable to the container to cover the second aperture, thereby isolating inside from outside the container. The second lid typically has one or more electrical connections providing electrical communication from a first side of the lid to a second side of the lid. The first and/or second lid may be referred to as a bulkhead.

The electrical connections in the first and/or second lid are typically sealed and/or air-tight, that is air, water and/or other fluid cannot pass from the first side of the lid to the second side of the lid and vice versa, when fluid pressure outside the container may be up to 30,000 kPa,40,000 kPa, and may be up to 45,000 kPa.

The first and/or second lid normally has a flange on the first side. This flange is typically engageable with a corresponding flange on the container near the first and/or second aperture. The first side of the first and/or second lid may comprise a seal. The seal typically extends around a surface of the lid so that when the surface is inside the container, the seal is contactable with an inner surface of the container near the first and/or second aperture. The seal may provide isolation between inside and outside the container when fluid pressure outside the container may be up to 30,000 kPa, 40,000 kPa and may be up to 45,000 kPa.

The apparatus typically includes one or more backplanes for providing electrical communication between the at least one printed circuit board in the container and/or the one or more electrical connections in the first and/or second lid. The apparatus may further include one or more backplanes for providing electrical communication between the two or more printed circuit boards in the container. The one or more backplanes may be rigid, semi-rigid or flexi-rigid.

The one or more fibre-optics typically have a first and a second end. The first end of the one or more fibre-optics is normally attached and/or in optical communication with the lid. The second end of the one or more fibre-optics is typically attached and/or in optical communication with the at least one printed circuit board normally through a connector, such as an SFP module. Normally the second end of the fibre optics have plugs which plug into the connector on the printed circuit board.

The one or more electrical connections in the first and/or second lid may terminate on the second side of the first and/or second lid in an electrical penetrator. The electrical penetrator typically comprises a body housing an aperture containing one or more conducting pins that are in electrical communication with the at least one printed circuit board in the container via the one or more wires or one or more backplanes. The electrical penetrator of the first and second lid may be the same. The electrical penetrator of the first and/or second lid may be a wet- or dry-mateable connector. The electrical penetrator of the first and/or second lid is normally part, typically an integral part of the first and/or second lid.

The electrical penetrator of the first and/or second lid is typically an interface or at least part of an interface between inside and the outside of the container.

The electrical penetrator of the first and/or second lid typically has more than 100, normally more than 200, and may be 267 conducting pins in electrical communication with the at least one printed circuit board in the container via the one or more wires and/ or one or more backplanes.

The Printed Circuit Board may be a Digital Processing Card (DPC). The Printed Circuit Board may be a fibre-optic board. Normally at least one of each is included. The apparatus may include a plurality of Printed Circuit Boards (PCB's) for example at least two, normally at least four and may be up to ten.

It may be an advantage of the present invention that the substantially rigid support provides support for the one or more fibre-optics between the one or more optical penetrators and the printed circuit boards.

The apparatus, especially between the pillars, may further comprise a connector parking module. The connector parking module typically includes a plurality of sockets. A plug on an end of a further set of one or more fibre-optics is typically receivable in a socket of the connector parking module. The one or more fibre-optics referred to above may be a first set of one or more fibre-optics.

The apparatus may further comprise a further set of one or more fibre-optics. The further set of one or more fibre-optics may have a first and a second end. The first end of the further set of one or more fibre-optics is normally attached with the lid. The second end of the further set of one or more fibre-optics can be attached to the connector parking module. The second end of the further set of one or more fibre-optics may terminate in a plug. A plug on the second end of the further set of one or more fibre-optics is typically receivable in a socket of the connector parking module.

It may be an advantage of the present invention that the connector parking module can therefore provide sockets for use in the future and thereby provide further connections, as, for example, part of an upgrade of the apparatus.

One or more of the one or more posts may be an integral part of the connector parking module.

In one embodiment, a further optical connector may be fitted to the lid and further two fibre optic PCBs included in the apparatus.

An embodiment of the invention will now be described by way of example only and with reference to the accompanying drawings, in which:

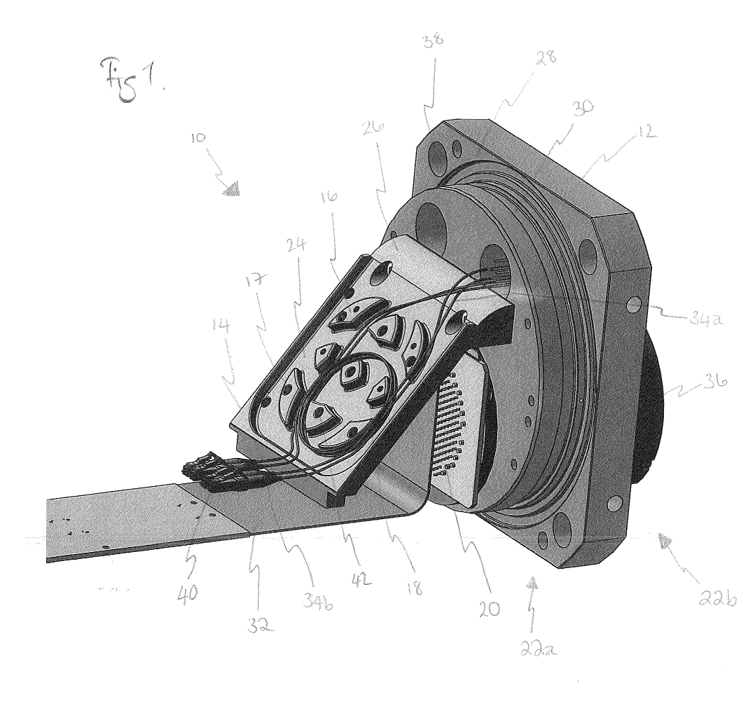

FIG. 1 is a perspective view of a substantially rigid support of an apparatus according to an embodiment of the present invention;

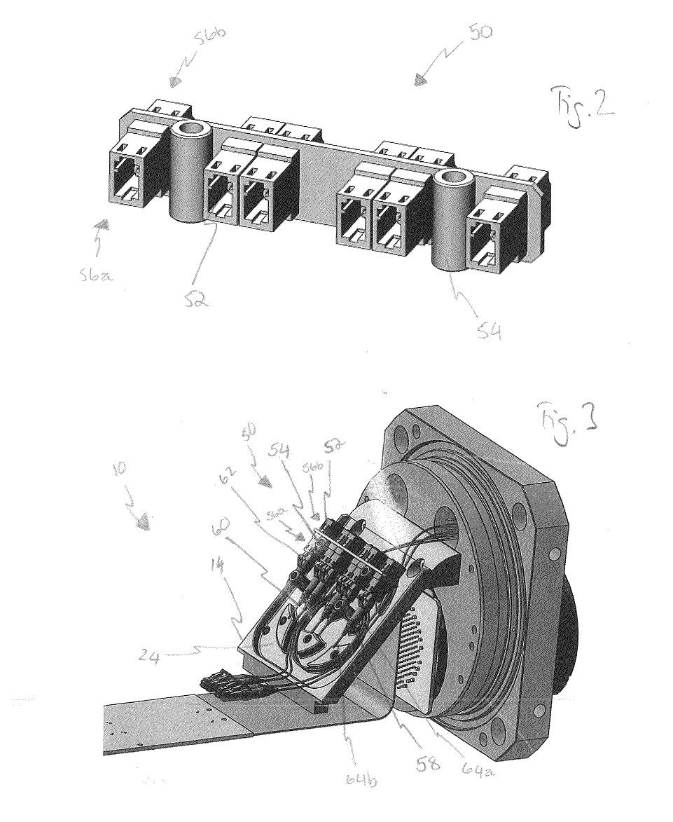

FIG. 2 is a perspective view of a connector parking module;

FIG. 3 is a perspective view of the connector parking module mounted on the substantially rigid support;

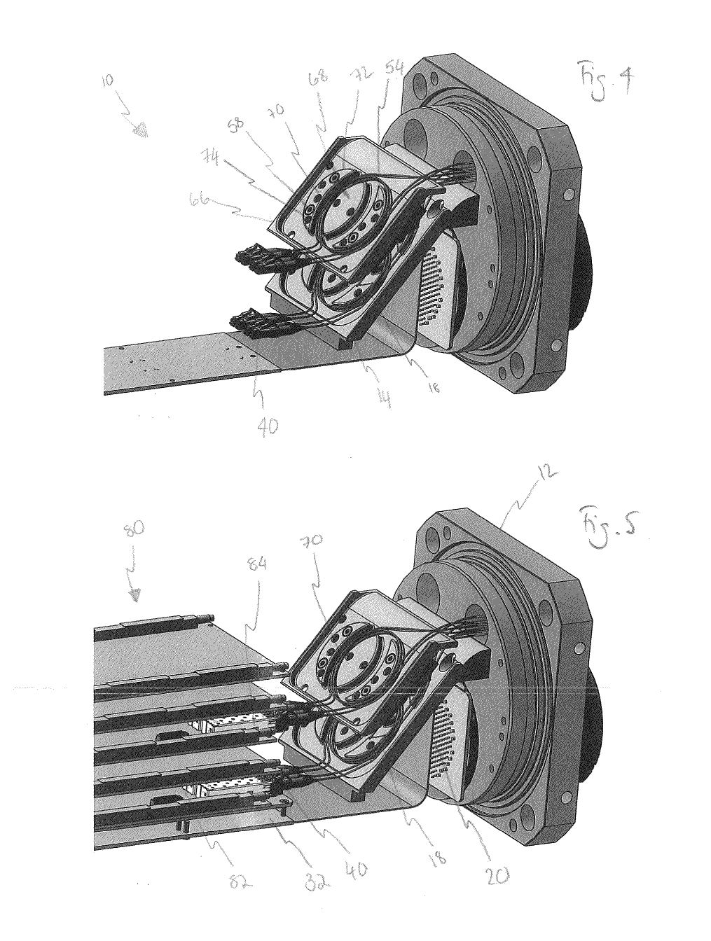

FIG. 4 is a perspective view of two substantially rigid supports; and

FIG. 5 is a perspective view of fibre-optics providing electrical communication between printed circuit boards in the container and electrical connections in the lid.

FIG. 1 is a perspective view of a portion of the apparatus 10 for use subsea. The apparatus 10 includes a container (not shown) having an aperture (not shown) and a lid 12 which is securable to the container to cover the aperture thereby isolating the inside from the outside of the container. The apparatus 10 also includes a substantially rigid support 14 located, in use, in the container. The substantially rigid support 14 is a fibre-optic cable management tray. The cable management tray 14 has an array of nine upstanding members 16. As described in more detail below, fibre optic cables 18 connect the lid 12 to printed circuit boards (not shown) within the container, whilst a semi-rigid backplane 32 provides electrical connection between pins 20 on the lid 12 and the printed circuit boards (PCBs). Communication may thus be made with the PCBs by either means, and they may be powered by the electrical connection. Fibre-optic cables 18 are located such that the smallest radius of a bend in the cables is greater than the minimum bend radius of the fibre-optic cables. The minimum bend radius of the fibre-optic cables 18 is 25 mm.

The array of upstanding members 16 define a plurality of pathways for the fibre-optic cables 18. The fibre-optic cables 18 are wound around the array of upstanding members 16 in the plurality of pathways. The array of upstanding members 16 have an outer curved surface 17.

Relative to a central point of the array the outer curved surface of the upstanding members 16 is concave. The portion of the curved surfaces on the relatively outer side of the array together form a general oval shape. Between them various options for wrapping the fibre optic cables is provided. Each upstanding member has three (wing-shaped) or four (shield-shaped) separate curved surfaces to provide a variety of different winding options.

In use, the fibre-optic cables 18 are in contact with and wrapped around the outer curved surface 17. The fibre-optic cables 18 are held in place on the cable management tray 14 by cable lacing (not shown) through holes 42 provided on the cable management tray.

The lid 12 of the apparatus 10 comprises 267 conducting pins 20 providing electrical communication from a first side 22a of the lid to a second side 22b of the lid.

The fibre-optic cables 18 provide optical communication between PCBs in the container and an optical penetrator in lid.

The cable management tray 14 is secured to the lid 12 in proximity to the 267 conducting pins 20 providing electrical communication from the first side 22a of the lid to the second side 22b of the lid.

The cable management tray 14 has a substantially planar face 24. The array of upstanding members 16 are on a substantially planar face 24. The substantially planar face 24 of the cable management tray is inclined (by around 50 degrees) to the first side 22a of the lid 12. There is a curved surface 26 between the cable management tray 14 and the lid 12. The curved surface has a radius greater than 25 mm. In use, the fibre-optic cables 18 rest on the curved surface.

When the apparatus 10 is assembled the first side 22a of the lid 12 is inside the container and the second side 22b of the lid forms part of an outer surface of the apparatus. When the lid 12 is secured to the container, the container is sealed and air-tight. The 267 conducting pins 20 in the lid 12 are sealed and air-tight, that is air, water and other fluid cannot pass from the first side 22a of the lid to the second side 22b of the lid and vice versa, when fluid pressure outside the container is up to, for example, 30,000 kPa.

The lid 12 has a flange 28 on the first side 22a. This flange 28 engages with a corresponding flange on the container near the aperture (not shown). The first side 22a of the lid 12 comprises a seal 30. Two seal (face and barrel) 30 extend around a surface of the lid 12 so that when the surface is inside the container, the seal is contactable with an inner surface of the container near the aperture. The seal 30 provide isolation between the inside and the outside of the container when fluid pressure outside the container is up to, for example, 30,000 kPa.

The apparatus 10 includes a backplane 32 for providing electrical power and communication between the PCBs in the container and the 267 conducting pins 20 in the lid 12. The backplane 32 is semi-rigid. Signals can be sent through either the fibre optic route or the electrical route—the former being preferred for longer distances.

The fibre-optic cables 18 have a first 34a and a second 34b end. The first end 34a of the fibre-optic cables 18 is permanently attached and in optical communication with the optical penetrator (not shown) in the lid 12. The second end 34b of the fibre-optic cables 18 is attached and in optical communication with the PCBs. The second end 34b of the fibre-optic cables 18 contains board connections 40. The board connections 40 are plugs.

The electrical penetrator 36 comprises a body housing an aperture containing the 267 conducting pins 20 that are in electrical communication with the PCBs in the container via the backplane 32.

The electrical penetrator 36 is a dry-mate connector. The electrical penetrator 36 is an integral part of the lid 12. The electrical penetrator 36 is an interface between the inside and the outside of the container.

FIG. 2 shows a connector parking module 50. The connector parking module 50 is designed to be a parking element for securely parking up to six fibre-optic cables. In use, this allows the possibility of future expansion of the apparatus 10.

The connector parking module 50 includes six sockets 52 on a first side 56a. Each socket on the first side 56a of the connector parking module 50 provides sockets for holding redundant fibre-optics. The connector parking module 50 also includes two posts 54.

FIG. 3 shows the connector parking module 50 mounted on the cable management tray 14 of the apparatus 10.

The apparatus 10 includes a second set of fibre-optic cables 60. The second set of fibre-optic cables 60 have a first 64a and a second 64b end. The first end 64a of the second set of fibre-optic cables 60 terminates in a plug 62. The plug 62 is received and secured in the sockets 52 on the first side 56a of the connector parking module 50.

The second end 64b of the second set of fibre-optic cables 60 are shown incomplete but can be used for future expansion. The sockets 52 on the second side 56b of the connector parking module 50 are empty.

The apparatus 10 also includes two posts 58 attached to the substantially planar face 24 of the cable management tray 14.

FIG. 4 shows the apparatus 10 with a first 14 and a second 66 cable management tray.

The connector parking module (not shown) is in place between the first 14 and second 66 cable management trays. The second cable management tray 66 is secured to the first cable management tray 14 using the posts 54 of the connector parking module 50 and the posts 58 attached to the substantially planar face 24 of the first cable management tray 14. In use, the posts 54,58 space the second cable management tray 66 from the first cable management tray 14. A further set of fibre-optic cables 70 are provided on the second cable management tray 66.

The second cable management tray 66 includes three upstanding members 68, one having a lens shape and the two surrounding members having concave shape. The three upstanding members 68 define a plurality of pathways for the fibre-optic cables 70. The further fibre-optic cables 70 are wound around the three upstanding members 68 and plurality of pathways. The three upstanding members 68 have an outer curved surface 72.

In use, the further fibre-optic cables 70 are in contact with and wrapped around the outer curved surface 72. The further fibre-optic cables 70 are held in place on the cable management tray 66 by cable lacing (not shown) through holes 74 provided on the cable management tray.

The further fibre-optic cables 70 have the same features as the fibre-optic cables 18.

FIG. 5 shows the maximum number of fibre-optic cables 18, 70 providing optical communication between the PCBs 80 in the container and an optical connector in lid. The PCBs 80 include a fibre-optic boards 82.

All the PCB's 82 connect to the backplane 32 to provide electrical communication between them and the 267 conducting pins 20 in the lid 12. Two of the PCB's 82 contain fibre optic connectors 84 to receive and secure the plug 40 at the second end 34b of the fibre-optic cables 18.

Modifications and improvements can be incorporated herein without departing from the scope of the invention.

1. An apparatus for use subsea, the apparatus comprising:
a. a container having at least one aperture;
b. a lid securable to the container to cover the at least one aperture, suitable to isolate the inside of the container from the outside of the container when fluid pressure outside the container is at least 1000 kPa;
c. at least one printed circuit board;
d. at least one fibre-optic connecting the printed circuit board to the lid; and
e. a substantially rigid support locatable in the container, the substantially rigid support having at least one upstanding member around which one or more fibre-optics are locatable such that the smallest radius of a bend in the one or more fibre-optics is greater than the minimum bend radius of the one or more fibre-optics.

2. An apparatus as claimed in claim 1, wherein the minimum bend radius of the one or more fibre-optics is from 10 to 200 mm, normally from 10 to 100 mm and optionally from 10 to 30 mm.

3. An apparatus as claimed in claim 1, wherein the at least one or each upstanding member has a curved outer surface and a radius of curvature is greater than the minimum bend radius of the one or more fibre-optics.

4. An apparatus as claimed in claim 3, wherein the curved outer surface is separated into more than one curved portion each portion with a different radius of curvature.

5. An apparatus as claimed in claim 1, comprising at least three upstanding members which define two or more pathways for the one or more fibre-optics.

6. An apparatus as claimed in claim 5, comprising an array of upstanding members having at least one upstanding member which is wing-shaped, and at least one which is shield-shaped.

7. An apparatus as claimed in claim 5, wherein a portion of their respective outer curved surfaces, on a relatively outer side of the array, defines a substantially oval pattern.

8. An apparatus as claimed in claim 5, wherein relative to a centre point between two or more upstanding members, the curved outer surface of at least a portion of the curved outer surface, is concave in shape.

9. An apparatus as claimed in claim 1, wherein at least one upstanding member is lens shaped.

10. An apparatus as claimed in claim 1, wherein the substantially rigid support has an at least substantially planar face which is inclined to a first side of the lid.

11. An apparatus as claimed in claim 10, wherein the angle of inclination is between 20-80 degrees, or between 40-60 degrees.

12. An apparatus as claimed in claim 10, wherein the substantially planar face of the substantially rigid support has a curved surface adjacent the lid with a radius of curvature greater than the minimum bend radius of the one or more fibre-optics.

13. An apparatus as claimed in claim 1, comprising a second substantially rigid support secured to the first substantially rigid support, the second substantially rigid support comprising at least one upstanding member.

14. An apparatus as claimed in claim 1, comprising a connector parking module which includes a plurality of sockets configured to receive a plug on an end of a fibre-optic.

15. An apparatus as claimed in claim 14, comprising a further set of one or more fibre-optics having a first and a second end, the first end attached to the lid and the second end of the further set of one or more fibre-optics having a plug which is received in the connector parking module.

16. An apparatus as claimed in claim 1, suitable to isolate the inside of the container from the outside of the container when fluid pressure outside the container is at least 10,000 kPa, or more than 20,000 kPa, or more than 30,000 kPa, or more than 40,000 kPa.

17. An apparatus in use, as claimed in claim 1, wherein the pressure inside the container is from 100 to 200 kPa.

18. An apparatus as claimed in claim 1, wherein the container is gas filled.

19. An apparatus as claimed in claim 1, comprising a plurality of printed circuit boards.

20. An apparatus as claimed in claim 1, comprising a Digital Processing Card (DPC).

21. An apparatus as claimed in claim 1, wherein the apparatus is a Subsea Electronic Module (SEM) used to control fluid, electrical lines and or other lines that pass through the tree and into a well.

22. An apparatus as claimed in claim 1, wherein the lid has one or more optical connectors for connection to the fibre optics and the one or more optical connections are one or more optical penetrators.

23. An apparatus as claimed in claim 1, wherein the lid further comprises one or more electrical connections providing electrical communication from a first side of the lid to a second side of the lid.

24. An apparatus as claimed in claim 23, wherein the apparatus includes one or more backplanes for providing electrical communication between the at least one printed circuit board in the container and/or the one or more electrical connections in the lid.
